(19) United States
(12) Patent Application Publication
(10) Pub. No.: US 2020/0373713 A1
(43) Pub. Date: Nov. 26, 2020

(54) COMBINED-TYPE BATTERY PACK TAB DEVICE WITH SWITCH UNIT

(71) Applicant: ZHEJIANG LERA NEW ENERGY POWER TECHNOLOGY CO., LTD, Ningbo City, Zhejiang Province (CN)

(72) Inventors: Bin LI, Ningbo City, Zhejiang Province (CN); Hongbo WANG, Ningbo City, Zhejiang Province (CN); Bai ZHANG, Ningbo City, Zhejiang Province (CN)

(21) Appl. No.: 16/637,211

(22) PCT Filed: Apr. 18, 2018
(86) PCT No.: PCT/CN2018/083591

§ 371 Date: Feb. 6, 2020

(30) Foreign Application Priority Data
Dec. 18, 2017 (CN) 201711367513.6

(51) Int. Cl. H01R 13/703; H01M 2/20; H01M 2/34

(52) U.S. Cl. CPC H01R 13/7032; H01M 2200/00; H01M 2/34; H01M 2/20

(57) ABSTRACT

A combined-type battery pack tab device has a switch unit, comprising a seat which is mounted on equipment and is provided with a plurality of male tabs that are matched with a male tab inside a batter pack, and the switch unit which has one end matched with the male tab and the other end is matched with a circuit in a piece of equipment. The battery pack tab device is provided with the switch unit, and the switch unit triggers the battery pack and the equipment into indirect conduction, which solves the problem of instant sparking at the moment when the battery pack and the equipment are triggered into direct conduction, eliminates the potential hazard of electric shock at the moment the battery pack and the equipment are separated, thus improving the operation safety of the battery pack.

### TECHNICAL FIELD

The disclosure which belongs to the technical field of machinery relates to a tab device, in particular to a combined-type battery pack tab device with a switch unit.

### DESCRIPTION OF RELATED ART

Within direct-current type gardening tools (which adopt direct current), controllers and discharging board circuits are configured with a relatively large input capacitor. Such capacity is necessary. When a battery pack is inserted into a piece of equipment, at the moment a female tab on the battery pack contacts a male tab on the equipment, the capacitor is electrically charged by a current which approaches to the short-circuit current, and instant sparking occurs between touching contacts of the male and female tabs due to the very large current, which causes damage to metal surface. After the battery pack is pulled to separate from the equipment, charges stored in the capacitor are hardly consumed in a short time, and if the level in the capacitor is higher than 36V, the risk of electric shock to human body is generated.

In conclusion, a tab device which can solve the problem of instant sparking at the moment and eliminate the risk of electric shock when the battery pack is plugged and pulled and improve the operation safety of battery pack is required.

### BRIEF SUMMARY OF THE INVENTION

Aiming at existing technical problems, the objective of the disclosure is to provide a tab device which can solve the problem of instant sparking and eliminate the risk of electric shock at the moment when a battery pack is plugged or pulled and can improve the operation safety of the battery pack.

The objective of the disclosure can be achieved with the following technical solution: A combined-type battery pack tab device with a switch unit includes a seat which is mounted on the device, the seat provided with a plurality of male tabs that are matched with a female tab inside a battery pack, and a switch unit having one end matched with the male tabs, the switch unit having the other end electrically connected with a circuit in equipment.

In the combined-type battery pack tab device with a switch unit, the battery pack, the switch unit and the equipment are progressively triggered into conduction in a stepwise way.

In the combined-type battery pack tab device with a switch unit, the switch unit and the battery pack are triggered into conduction by contact.

In the combined-type battery pack tab device with a switch unit, the switch unit and the male tabs on the seat are triggered into conduction by point-to-point contact.

In the combined-type battery pack tab device with a switch unit, the switch unit is integrated at the seat, and the switch unit has a trigger portion arranged opposite to a trigger portion on the male tab; or the switch unit and the seat are separately arranged, and the switch unit is mounted on the equipment.

In the combined-type battery pack tab device with a switch unit, when the switch unit is integrated at the seat, the switch unit and the seat are in a detachable connection, or the switch unit and the seat are integrally structured.

In the combined-type battery pack tab device with a switch unit, the switch unit comprises a housing connected with the seat, wherein the housing is internally provided with a tilted plate component, wherein the tilted plate component has one end point in an inserted connection with the seat, and the titled plate component has the other end matched with the trigger portion of the male tab.

In the combined-type battery pack tab device with a switch unit, the titled plate component comprises a first contact sheet, and a second contact sheet and a trigger part which are connected to one end of the first contact sheet, wherein the trigger part and the second contact sheet are respectively located on two sides of the first contact sheet, and the trigger part has one end inserted into the seat.

In the combined-type battery pack tab device with a switch unit, the first contact sheet is provided with a contact point arranged opposite to the contact point of the male tab that is inserted into the housing, wherein the second contact sheet has one end which extends out of the housing.

### Beneficial Effects

Compared with the prior art, the combined-type battery pack tab device with a switch unit has the following beneficial effects. The battery pack tab device is provided with the switch unit; the switch unit triggers the battery pack and equipment into indirect conduction, which solves the problem of instant sparking at the moment when the battery pack and the equipment are triggered into direct conduction, eliminates the potential hazard of electric shock at the moment when the battery pack is separated from the equipment, thus improving the operation safety of the battery pack; besides, the arrangement of the switch unit avoids the use of a relay or an MOS tube in a charging and discharging circuit of the capacitor, saving the production cost of the battery pack.

### BRIEF DESCRIPTION OF THE SEVERAL VIEWS OF THE DRAWINGS

FIG. 1 is a structural view of a combined-type battery pack tab device with a switch unit;

FIG. 2 is a local view of the structural view of a combined-type battery pack tab device with a switch unit.

In the drawings, 100—seat; 110—male tab; 200—switch unit; 210—housing; 220—titled plate component; 221—first contact sheet; 222—second contact sheet; 223—trigger part; 224—contact.

### DETAILED DESCRIPTION OF THE INVENTION

The technical solution of the disclosure is further described in detail below in conjunction with the specific embodiment and attached drawings of the disclosure. However, the disclosure is not limited to the embodiment below.

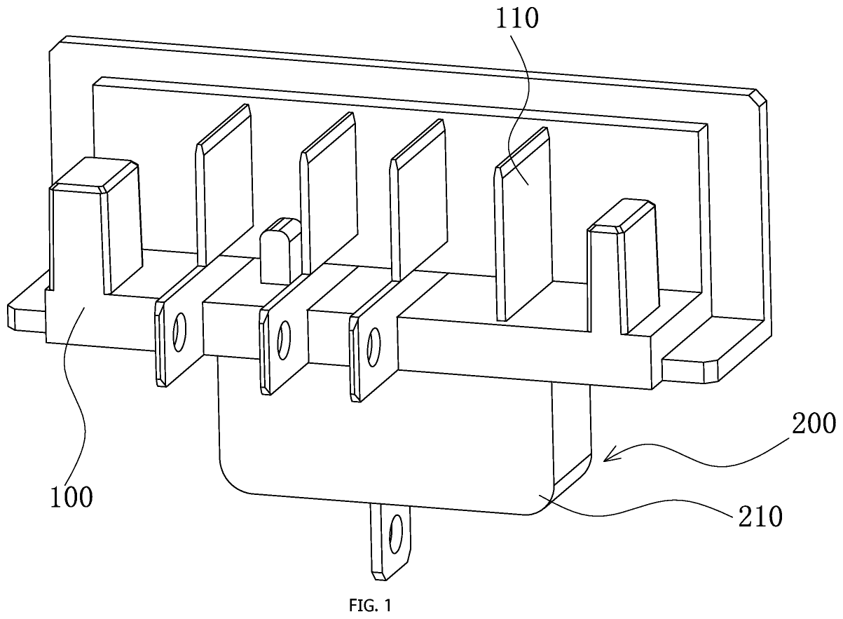

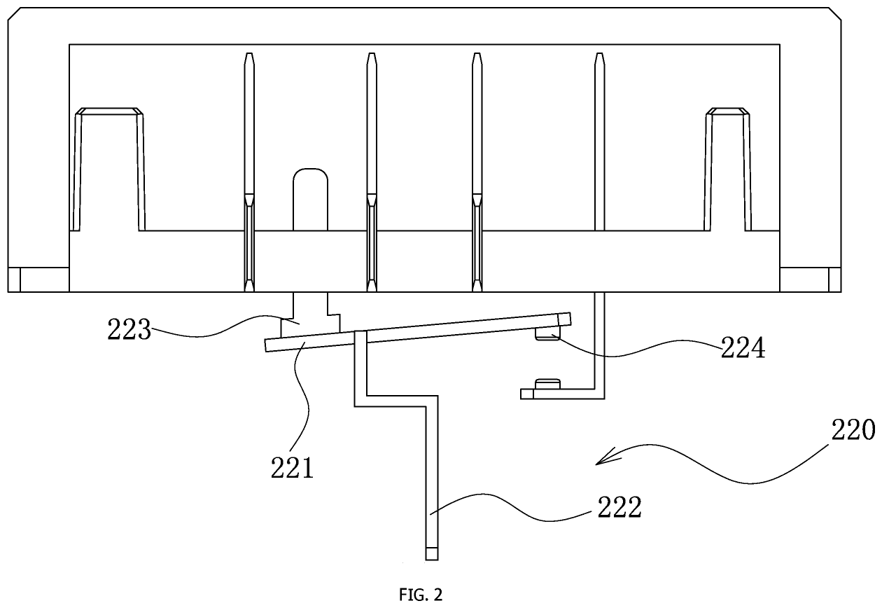

As shown in FIG. 1 and FIG. 2, the disclosure provides a combined-type battery pack tab device with a switch unit, including a seat 100 mounted on a piece of equipment (a gardening tool), the seat 100 provided with a plurality of male tabs 110 which are matched with a male tab in a battery pack, and a switch unit 200 with one end matched with the male tabs 110, the switch unit 200 having the other end electrically connected with a circuit in the equipment. When the battery pack is inserted into the equipment, the female tab in the battery pack is connected with the male tab 110 on the seat 100 by contact first along with the continuous inward movement of the battery pack. However, the switch unit 200 and the male tab 100 are not in communication at this moment, which means that the current loop between the battery pack and the equipment is not turned on. As the battery pack continues to extend into the equipment until the switch unit 200 communicates with the male tab 110, the current loop between the battery pack and the equipment is turned on.

According to the combined-type battery pack tab device with a switch unit provided by the disclosure, the battery pack tab device is provided with the switch unit 200, and the switch unit 200 triggers the batter pack and the equipment into indirect conduction, which solves the problem of instant sparking at the moment when the battery pack and the equipment are triggered into direct conduction, and eliminates the potential hazard of electric shock at the moment when the battery pack and the equipment are separated, thus improving the operation safety of the battery pack; besides, the arrangement of the switch unit 200 avoids the use of a relay or an MOS tube in a charging and discharging circuit of a capacitor, saving the production cost of the battery pack.

In this embodiment, the switching circuit of the MOS tube is a circuit made in the principle that a grid electrode (g) of the MOS tube controls the on-off of a source electrode (s) and a drain electrode (d) of the MOS tube.

Further preferably, as shown in FIG. 1 and FIG. 2, the battery pack, the switch unit 200 and the equipment are progressively triggered into conduction in a stepwise way. When the battery pack is inserted into the equipment, the male tab on the seat 100 well contacts the female tab in the battery pack, and the connection between the male and female tabs is switched on as the battery pack continues to extend into the equipment and reaches 50% of the insertion journey. However, the switch unit 200 and the male tab 110 do not yet contact directly, which means that the switch unit 200 and the male tab 110 are not triggered into conduction, and no current exists in the circuit between the battery pack and the equipment at this time, so that no sparking phenomenon occurs. As the battery pack continues to extend into the equipment and reaches 70% of the insertion journey, the switch unit 200 is pressed by the battery pack to trigger the communication between the switch unit 200 and the male tab 110, so that a current appears in the circuit between the battery pack and the equipment, which means that the connection between the battery pack and the equipment is switched on. The conduction between the switch unit 200 and the battery pack is switched on instantly, so that even if sparking occurs, the equipment and the battery pack are not damaged because the sparking time is too short. When the battery pack is pulled to leave the equipment, the switch unit 200 is released, so that the circuit between the switch unit 200 and the battery pack is cut off, and the circuit between the battery pack and the equipment is cut synchronously, thus avoiding the occurrence of the electric shock.

Preferably, as shown in FIG. 1 and FIG. 2, the switch unit 200 are triggered into conduction by contact (touch) with both the equipment and the battery pack, improving the operation safety of the battery pack and the equipment. Further preferably, the switch unit 200 and the circuit of the equipment are triggered into conduction by contact via a lead, and the switch unit 200 and the male tab 110 at the seat are triggered into conduction by point-to-point contact, wherein the reason why the switch unit 200 and the male tab 110 at the seat are triggered into conduction by point-to-point contact, wherein the contact area between the switch unit 200 and the male tab 110 is reduced, is to ensure instant completion of the conduction between the equipment and the battery pack via the switch unit 200, thus avoiding sparking phenomenon and improving the operation safety of the battery pack. Besides, when the battery pack is pulled to leave the equipment and release the switch unit 200, the switch unit 200 and the male tab 110 can be separated instantly, thereby cutting off the electrical connection between the battery pack and the equipment and further avoiding the occurrence of the phenomenon at a contact 224.

Preferably, as shown in FIG. 1 and FIG. 2, the switch unit 200 is integrated at the seat 100, and the switch unit 200 has a trigger portion arranged opposite to a trigger portion on the male tab 110; or, the switch unit 200 and the seat 100 are separately arranged, and in such circumstance, the switch unit 200 is arranged at any position of the equipment; when the battery pack is inserted into the equipment, the battery pack and the equipment are triggered into conduction through the conduction between the male tab 110 of the seat 100 and the switch unit 200, thus improving the installation flexibility of the switch unit 200.

As shown in FIG. 1 and FIG. 2, in the case that the switch unit 200 is integrated at the seat 100, the switch unit 200 and the seat 100 can be connected in two ways. According to one connection way, the switch unit 200 and the seat 100 are in a detachable connection, which means that the switch unit 200 is fixed on the seat 100 with threaded fastenings. According to the other connection way, the switch unit 200 and the seat 100 are integrally structured, which means that the switch unit 200 and the seat 100 are a fixed connection, wherein the fixed connection can be obtained in the following way: during molding, the seat 100 and the switch unit 200 are placed in one die, so that the die made through injection molding includes the structure of the seat 100 and also includes the structure of the switch unit 200, thus simplifying the manufacturing process of the tab device and further reducing the production cost of the battery pack.

Preferably, as shown in FIG. 1 and FIG. 2, the switch unit 200 includes a housing 210 connected with the seat 100, wherein the housing 210 is internally provided with a titled plate component 220, the titled plate component 220 has one end point which is an insert connection with the seat 100, and the titled plate component 220 has another end point matched with a trigger portion in the male tab 110. When the end connected with the seat 100 is pressed, the end matched with the male tab 110 falls down and touches the male tab 110 to switch on the connection between the equipment and the battery pack and avoid the sparking phenomenon. When the end matched with the male tab 110 is released, the one matched with the male tab 110 is titled and quickly separated from the male tab 110 to cut off the electrical connection between the equipment and the battery pack and avoid the occurrence of electric shock.

Further preferably, as shown in FIG. 1 and FIG. 2, the titled plate component 220 includes a first contact sheet 221, and a second contact sheet 222 and a trigger part 223 that are connected to one end of the first contact sheet 221, wherein the trigger part 223 and the second contact sheet 222 are respectively located on two sides of the first contact sheet 221, the contact trigger 223 has one end inserted into the seat 100, the first contact sheet 221 is provided with a contact 224 arranged opposite to the contact 224 on the male tab 110 which is inserted into the housing 210, and the second contact sheet 222 has one end extending out of the housing 210. When the switch unit 200 is pressed (when the trigger part 223 is pressed), the contact 224 on the first contact sheet 221 touches the contact 224 on the male tab 110, thus switching on the circuit between the battery pack and the equipment.

In this embodiment, the touching part between the contact 224 on the first contact sheet 221 and the contact 224 on the male tab 110 is located in the housing 210, ensuring safety when the connection between the switch unit 200 and the battery pack are connected. Further preferably, the surface of the contact 224 on the first contact sheet 221 is treated by processes such as silver plating, thus ensuring dozens of thousands of on-off operations of the switch unit 200 and further prolonging the service life of the battery pack.

Specific embodiment described in this text is merely intended to illustrate the concept of the disclosure. Those skilled in the art of the disclosure can make various modifications, supplements or similar substitutions to the described specific embodiment, which shall fall within the concept of the disclosure and the protective scope defined by the claims.

What is claimed is:

1. A combined-type battery pack tab device with a switch unit, characterized by comprising a seat which is mounted on the device, the seat provided with a plurality of male tabs that are matched with a female tab inside a battery pack, and a switch unit having one end matched with the male tabs, the switch unit having the other end electrically connected with a circuit in equipment.

2. The combined-type battery pack tab device with a switch unit according to claim 1, wherein the battery pack, the switch unit and the equipment are progressively triggered into conduction in a stepwise way.

3. The combined-type battery pack tab device with a switch unit according to claim 1, wherein the switch unit and the battery pack are triggered into conduction by contact.

4. The combined-type battery pack tab device with a switch unit according to claim 3, wherein the switch unit and the male tabs on the seat are triggered into conduction by point-to-point contact.

5. The combined-type battery pack tab device with a switch unit according to claim 1, wherein the switch unit is integrated at the seat, and the switch unit has a trigger portion arranged opposite to a trigger portion on the male tab; or the switch unit and the seat are separately arranged, and the switch unit is mounted on the equipment.

6. The combined-type battery pack tab device with a switch unit according to claim 5, wherein when the switch unit is integrated at the seat, the switch unit and the seat are in a detachable connection, or the switch unit and the seat are integrally structured.

7. The combined-type battery pack tab device with a switch unit according to claim 1, wherein the switch unit comprises a housing connected with the seat, wherein the housing is internally provided with a tilted plate component, wherein the tilted plate component has one end point in an inserted connection with the seat, and the titled plate component has the other end matched with the trigger portion of the male tab.

8. The combined-type battery pack tab device with a switch unit according to claim 7, wherein the titled plate component comprises a first contact sheet, and a second contact sheet and a trigger part which are connected to one end of the first contact sheet, wherein the trigger part and the second contact sheet are respectively located on two sides of the first contact sheet, and the trigger part has one end inserted into the seat.

9. The combined-type battery pack tab device with a switch unit according to claim 8, wherein the first contact sheet is provided with a contact point arranged opposite to the contact point of the male tab that is inserted into the housing, wherein the second contact sheet has one end which extends out of the housing.
